(19) United States
(12) Patent Application Publication
(10) Pub. No.: US 2025/0115209 A1
(43) Pub. Date: Apr. 10, 2025

(54) System and Method of Immobilizing a Vehicle to Prevent Vehicle Theft

(71) Applicants: Bruno Thierry Robert Pellichero, Airdrie (CA); Hermann B. Cuadros, Springfield, VA (US)

(72) Inventors: Bruno Thierry Robert Pellichero, Airdrie (CA); Hermann B. Cuadros, Springfield, VA (US)

(21) Appl. No.: 18/772,985

(22) Filed: Jul. 15, 2024

Related U.S. Application Data
(60) Provisional application No. 63/588,934, filed on Oct. 9, 2023.

(51) Int. Cl. B60R 25/04; B60R 16/023

(52) U.S. Cl. CPC B60R 25/04; B60R 16/0231

(57) ABSTRACT

A system and method are used for immobilizing a vehicle to prevent vehicle theft. The system includes an immobilizer that can be retrofitted to the selected vehicle or integrated into the vehicle during the manufacturing process. The immobilizer includes a communication module that enables the immobilizer to be remotely controlled using a wireless signal. The wireless signal can be transmitted using different secure protocols including, but not limited to, Wi-Fi or Bluetooth encrypted signals. In addition, the wireless signal can be relayed over different secure networks. Further, the immobilizer may include one or more connectors and the corresponding wiring harnesses that enable the hardwire connection of the immobilizer to the appropriate vehicle component. Additionally, different methods such as disabling one or more data lines or disabling one or more engine sensors of the corresponding vehicle may be employed for immobilizing the vehicle.

### FIELD OF THE INVENTION

The present invention relates generally to theft prevention systems. More specifically, the present invention provides a novel method of preventing vehicle theft by immobilizing the vehicle when a theft attempt is detected.

### BACKGROUND OF THE INVENTION

Vehicle theft is a major issue around the world. Even with the development of more advanced safety technologies, people have been able to bypass the safety features of vehicles. For example, many vehicles have been able to be easily stolen without the use of a key or having to hot-wire the vehicle due to an exploit found in vehicles that lack an immobilizer. A vehicle immobilizer is a standard security feature in many vehicles that prevents the vehicle from starting or being driven unless the correct key or key fob is being used. Vehicle immobilizers have become an important feature due to the rise in popularity of remote start, keyless fobs, etc. However, there are ways to bypass the vehicle immobilizers, and these hacks are often exploited by knowledgeable thieves. Further, manufacturers and suppliers are often slow to provide solutions to fix these issues that leave vehicle owners with few options to protect their vehicles. So, there is a need for a better vehicle immobilizer to prevent vehicle thefts.

An objective of the present invention is to provide a novel system and method of immobilizing a vehicle to prevent vehicle theft. The present invention accomplishes this by interrupting or disabling access to the vehicle's Engine Control Unit (ECU). The ECU disruption by the present invention can be performed in different ways to reduce the chances of thieves from bypassing the present invention. Another objective of the present invention is to provide a system and method of immobilizing a vehicle to prevent vehicle theft that can be remote controlled. The present invention enables the vehicle owner to control the immobilization of the vehicle remotely and selectively. The remote capabilities of the present invention also enable users to control several vehicles if necessary. Another objective of the present invention is to enable the retrofitting of the present invention to a vehicle or for the installation of the present invention to the vehicle during the manufacturing process. Additional features and benefits of the present invention are further discussed in the sections below.

### SUMMARY OF THE INVENTION

The present invention provides a system and method of immobilizing a vehicle to prevent vehicle theft. The system of the present invention includes an immobilizer that can be retrofitted to the selected vehicle or integrated into the vehicle during the manufacturing process. The immobilizer includes a communication module that enables the immobilizer to be remotely controlled using a wireless signal. The wireless signal can be transmitted using different secure protocols including, but not limited to, Wi-Fi or Bluetooth encrypted signals. In addition, the wireless signal can be relayed over different secure networks. Further, the immobilizer of the present invention can include one or more connectors and the corresponding wiring harnesses that enable the hardwire connection of the immobilizer to the appropriate vehicle component. Furthermore, the immobilizer of the present invention can be equipped with a watertight enclosure that protects all the components of the immobilizer.

### BRIEF DESCRIPTIONS OF THE DRAWINGS

FIG. 1 is a schematic view of the present invention, wherein a single vehicle immobilizer is shown remotely controlled.

FIG. 2 is a schematic view of the present invention, wherein several vehicle immobilizers are shown remotely controlled.

FIG. 3 is a schematic view of the present invention, wherein the vehicle immobilizer is shown connected to the vehicle ECU to disable one or more data lines.

FIG. 4 is a schematic view of the present invention, wherein the vehicle immobilizer is shown connected to the vehicle ECU to disable a first engine sensor.

FIG. 5 is a schematic view of the present invention, wherein the vehicle immobilizer is shown connected to the vehicle ECU to disable a second engine sensor.

FIG. 6 is a flowchart showing a first method of the present invention, wherein the vehicle immobilizer is connected to the vehicle ECU to disable one or more data lines.

FIG. 7 is a flowchart showing a second method of the present invention, wherein the vehicle immobilizer is connected to the vehicle ECU to disable one or more engine sensors.

### DETAIL DESCRIPTIONS OF THE INVENTION

All illustrations of the drawings are for the purpose of describing selected versions of the present invention and are not intended to limit the scope of the present invention.

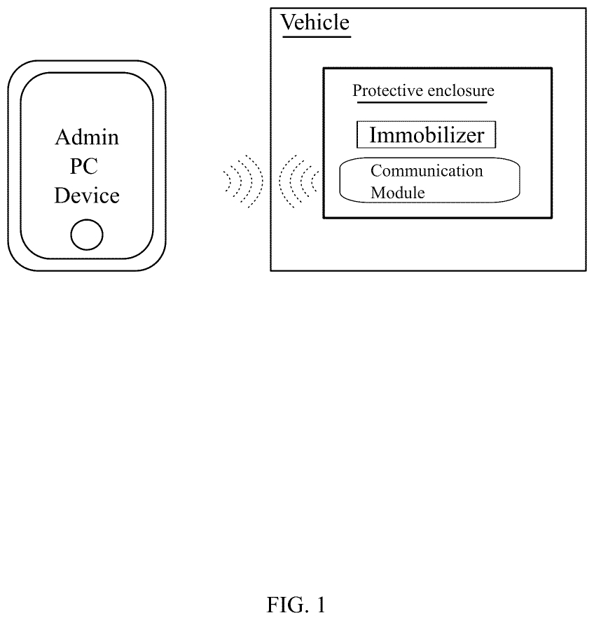

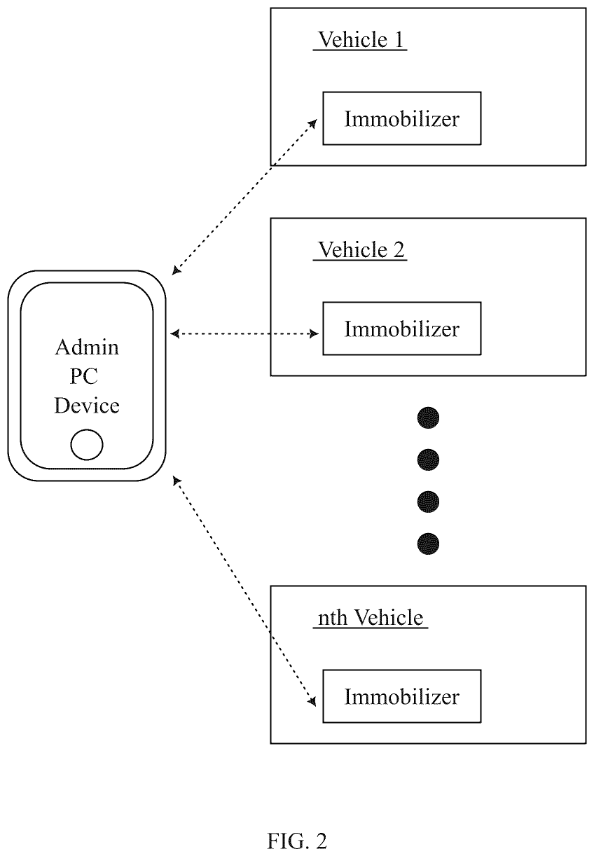

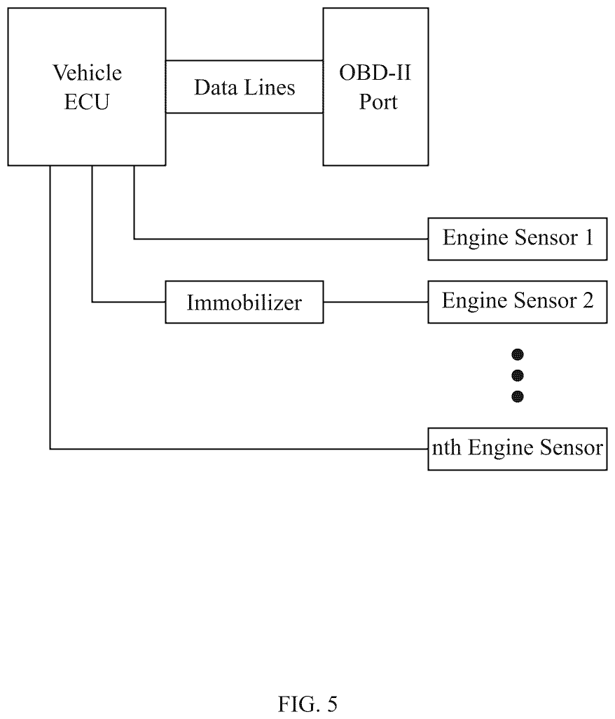

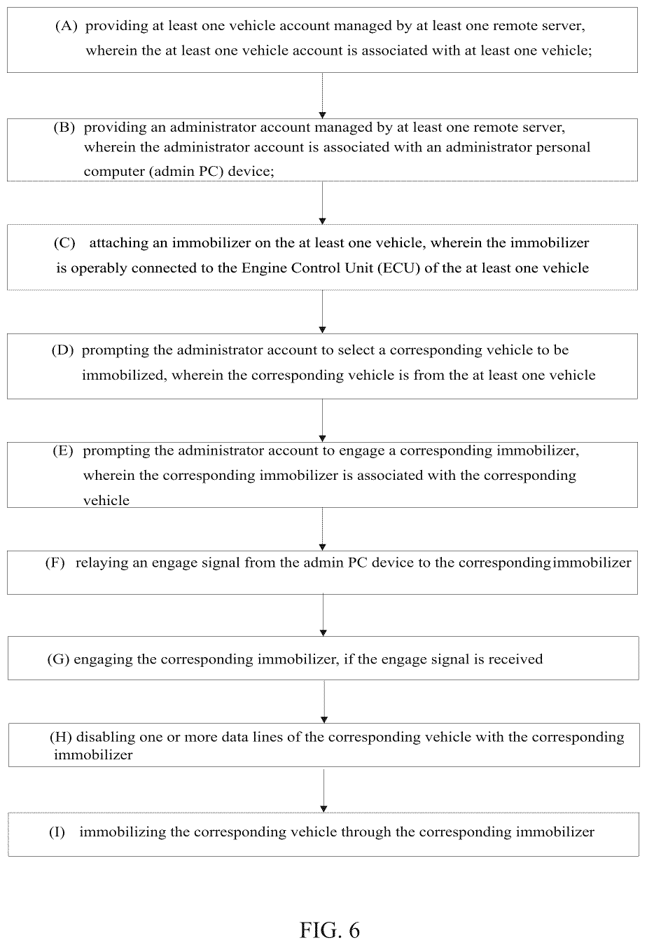

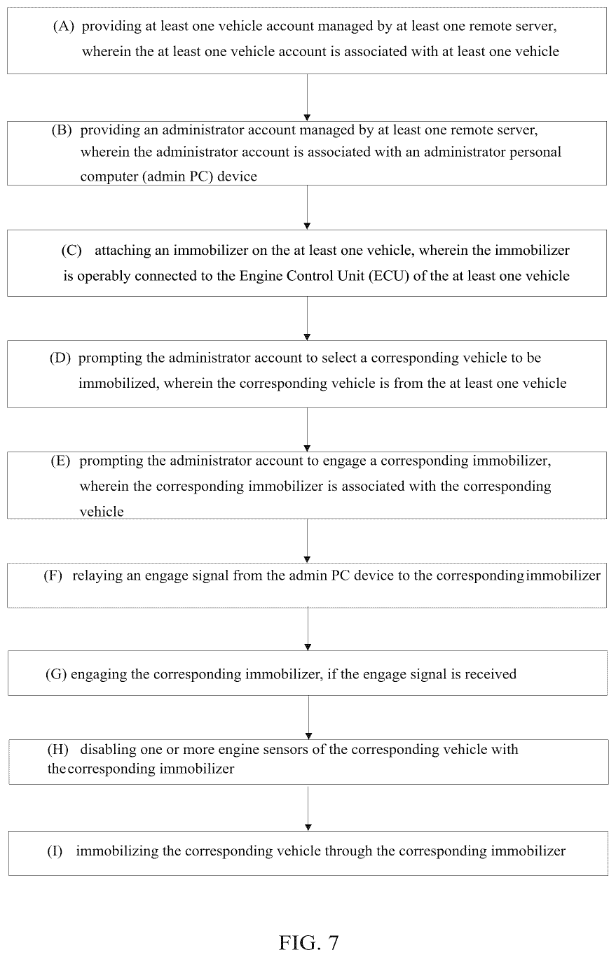

The present invention provides a system and a method for immobilizing a vehicle. The present invention immobilizes the vehicle using different methods that interrupt the access to the vehicle's Engine Control Unit (ECU). The following description is in reference to FIG. 1 through FIG. 7. As can be seen in FIG. 1, FIG. 6 and FIG. 7, the system used to implement the method of the present invention is provided with at least one vehicle account managed by at least one remote server (Step A). The at least one vehicle account is associated with at least one vehicle. The vehicle account enables the storage of vehicle information on the immobilizer that can be used for administrative functions. Further, the system used to implement the method of the present invention is provided with an administrator account managed by at least one remote server (Step B). The administrator account enables the vehicle owner or authorized user to remotely manage the immobilizer of one or more vehicles. Further, the administrator account is associated with an administrator personal computer (admin PC) device or a Cell phone Application that enables the user to perform the different administrative functions, such as remotely engaging the immobilizer. More specifically, the administrator account is tied to a single user who is able to interact, participate, and operate the corresponding admin PC device during the immobilizing process. The admin PC device allows a user to interact with the present invention and can be, but is not limited to, a smart phone, a cell phone application, a laptop, a desktop, or a tablet PC. To that end, the present invention works on operating systems, mobile applications, and/or may be embedded into websites. The remote server is used to facilitate communication between the plurality of user accounts. Moreover, the remote server is used to execute a number of internal processes for the present invention and is used to store message data.

As previously discussed, the present invention can implement different means to immobilize the vehicle that reduces the chances of unauthorized users bypassing the immobilizer. Accordingly, the overall method of the present invention further comprises the steps of attaching an immobilizer on the at least one vehicle (Step C). As can be seen in FIG. 1 through FIG. 5, the system of the present invention includes an immobilizer that can be installed on a vehicle. The immobilizer can be designed to be retrofitted to the vehicle or be installed on the vehicle during the manufacturing process. The immobilizer is provided with the appropriate connectors and the corresponding wiring harnesses that enable the wiring of the immobilizer to the appropriate electronic components of the vehicle.

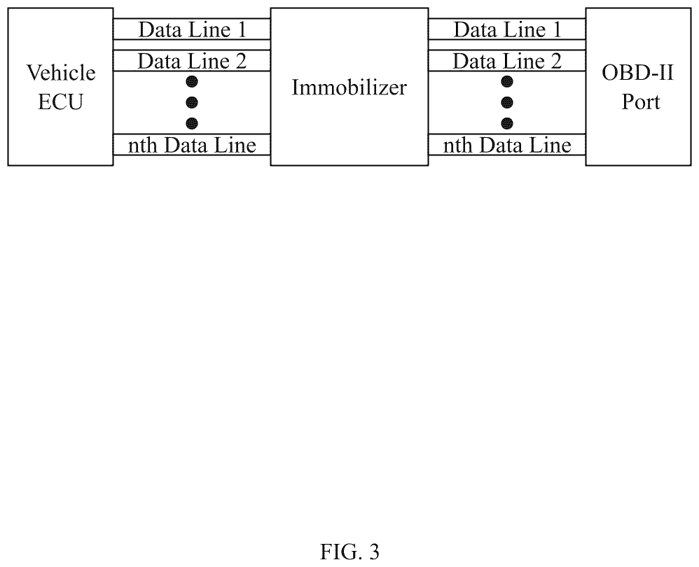

In order to implement different means to immobilize the vehicle, the overall method of the present invention comprises the steps of prompting the administrator account to select a corresponding vehicle to be immobilized (Step D). In other words, the administrator or user selects a particular vehicle from at least one vehicle through an application or through a link in the admin PC device. More specifically, the corresponding vehicle is from the at least one vehicle. For example, the corresponding vehicle may be a single vehicle from a bunch of vehicles in a dealership or a personal vehicle of an individual user. The overall method further comprises the steps of prompting the administrator account to engage a corresponding immobilizer (Step E). Here, the corresponding immobilizer is associated with the corresponding vehicle. In other words, the corresponding immobilizer is the immobilizer that has been installed in the corresponding vehicle. Once the administrator account is ready and has selected the corresponding device, an engagement signal is relayed from the admin PC device or cell phone application to the corresponding immobilizer (Step F). Subsequently, the overall method comprises the steps of engaging the corresponding immobilizer, if the engage signal is received (Step G). As previously discussed, the present invention can implement different means to immobilize the vehicle that reduces the chances of unauthorized users bypassing the immobilizer. As can be seen in FIG. 3 and FIG. 6, a method of the present invention to immobilize the vehicle involves disabling the data lines to the ECU, irrespective of whether the vehicle is running or not. In other words, the overall method comprises the steps of disabling one or more data lines of the corresponding vehicle with the corresponding immobilizer (Step H). In this embodiment, the immobilizer disables the ECU by either connecting the immobilizer directly in line with the Onboard Diagnostic connector (OBD2 Connector). Alternatively, the immobilizer can be connected directly in line, at the ECU connector, by splicing the existing ECU's data lines into the immobilizer. The data lines can include, but are not limited to, SAE J1850 Bus, ISO15765-4/CAN Bus, ISO9141 K&L Lines, etc. The specific data lines can change according to the vehicle manufacturer's specifications that enable access to the ECU for diagnostic and programming purposes, such as maintenance and troubleshooting. Thus, the overall method of the present invention subsequently comprises the steps of immobilizing the corresponding vehicle through the corresponding immobilizer (Step I).

Continuing with the preferred embodiment, a subprocess of the method of the present invention includes the steps of providing a protective watertight enclosure and a communication module, wherein the at least one the immobilizer and the communication module are mounted within the protective watertight enclosure. In other words, the immobilizer is equipped with a protective watertight enclosure that protects all the immobilizer components. Further, the communication module enables remote controlling of the immobilizer through the admin PC device during steps (D) through (I). Example standards of what the wireless communication module is capable of using include, but are not limited to, Bluetooth, WI-FI, GSM, CDMA, ZigBee, etc.

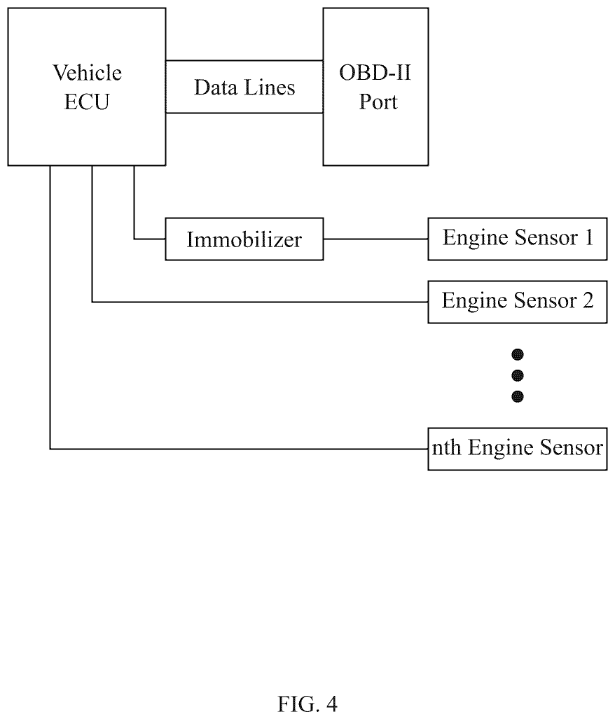

In another embodiment, and as seen in FIG. 7, the method of the present invention to immobilize the vehicle involves interrupting the vehicle engine's sensors signal(s) going to the ECU so that the ECU can no longer start and/or run the vehicle's engine. Interrupting the engine sensors immobilizes the vehicle since the ECU lacks the information needed to synchronize fuel injection and/or spark plugs ignition with the position of each piston/cylinder in the engine. Accordingly, in this embodiment, the overall method of the present invention after step G comprises disabling one or more engine sensors of the corresponding vehicle with the corresponding immobilizer (Step H). In this embodiment, one or more engine sensors comprise at least one of engine's timing sensor, accelerator pedal signal sensor, and engine's cam shaft sensor. In other words, and as can be seen in FIGS. 4, 5, and 7, authorized users can choose which engine sensor is interrupted depending on preference or, more importantly, depending on access to any of the engine sensors. For example, if the vehicle engine's timing sensor is too easy to access, then the timing sensor would not be a good choice since thieves could just as easily re-establish functionality by easily finding and removing the immobilizer from the circuit. Further, the accelerator pedal's signal is another sensor that can be interrupted so that the engine may be started but the accelerator would not be usable. Thus, the vehicle would be left idle without any possibility of increasing engine power. Further, the vehicle timing sensor is another sensor that can be interrupted to immobilize the vehicle. The engine would be impossible to start as the ECU would not be able to determine the position of each piston in the engine so that the ECU could not initiate any fuel injection or spark plug ignition. Further, the vehicle engine's cam shaft sensor is another sensor that can be interrupted by this immobilizer. The ECU would not be able to determine the cam shaft position within the engine which disables the starting of the engine or strictly run it in “Safe Mode”, which dramatically reduces the power the engine can produce. Further, the vehicle's fuel pump power wire/relay is also a component that can be interrupted by the immobilizer. The vehicle's engine could not be started for lack of fuel going to the engine. In other embodiments, different sensors or components can be selectively disabled to immobilize the vehicle.

As previously discussed, the system of the present invention enables authorized users to perform different administrative functions using the corresponding administrator PC device. More specifically, the vehicle account enables the storage of the vehicle information on the immobilizer for enabling administrative functions. To that end, a subprocess of the present invention comprises the steps of providing a user interface (UI). The subprocess continues by enabling the administrator account to manage the at least one vehicle with the at least one immobilizer remotely, through the UI on the corresponding admin PC device. That is, in the preferred embodiment, the system of the present enables the authorized user to manage the vehicle with an installed immobilizer remotely. More specifically, through the UI on the corresponding administrator PC device, the authorized user can create a vehicle account that stores different information about the vehicle that is equipped with the immobilizer, such as the vehicle year, brand, color, VIN number, etc. Authorized users can create and store several vehicle accounts so that the authorized users can manage different vehicles with the corresponding immobilizers. For example, dealerships can manage the vehicles in the dealership's inventory so that all vehicles equipped with an immobilizer can be remotely managed. The UI can include a feature that enables the authorized user to manage the several vehicle accounts collectively or individually. Furthermore, the UI can enable the authorized user to edit or erase existing vehicle accounts. For example, if a vehicle is sold, the authorized user can remove the vehicle from the corresponding administrator PC device so that the new owner can solely control the immobilizer.

Further, the system of the present invention also enables the implementation of different user profiles that enables several users to temporarily have authorization to engage the immobilizer on the corresponding the vehicle. To that end, a subprocess of the present invention comprises the steps of providing a plurality of temporary user accounts. Furthermore, the subprocess continues by enabling the plurality of temporary user accounts to temporarily have authorization to engage the immobilizer on the corresponding vehicle. For example, if the vehicle owner lends the vehicle to a family member, the vehicle owner can provide temporary access to the family member so that the family member can activate the immobilizer when necessary. Further, each user profile can store different user preferences that correspond to the method of choice to immobilize the vehicle when necessary. More specifically, each of the temporary user accounts stores different user preferences that correspond to a method of choice to immobilize the corresponding vehicle. The user's preference is determined upon installation of the immobilizer using a specific wiring harness. So, the same brand/model of vehicle can be immobilized by using different sensors or data lines interrupting methods. In other words, the administrator account's choice on how to immobilize the vehicle is determined upon installation of the immobilizer using a specific wiring harness. This increases the safety of the vehicle to prevent unauthorized users from getting vehicle information. If the immobilizer is set to disrupt the vehicle engine's sensors, the vehicle owner can disable the corresponding immobilizer so that the dealership can perform the required maintenance. In other embodiments, different administrative features can be implemented that allow the authorized user to better manage the immobilizer of the corresponding vehicle.

Although the invention has been explained in relation to its preferred embodiment, it is to be understood that many other possible modifications and variations can be made without departing from the spirit and scope of the invention.

1. A method of immobilizing a vehicle comprising the steps of:
(A) providing at least one vehicle account managed by at least one remote server, wherein the at least one vehicle account is associated with at least one vehicle;
(B) providing an administrator account managed by at least one remote server, wherein the administrator account is associated with an administrator personal computer (admin PC) device;
(C) attaching an immobilizer on the at least one vehicle, wherein the immobilizer is operably connected to the Engine Control Unit (ECU) of the at least one vehicle;
(D) prompting the administrator account to select a corresponding vehicle to be immobilized, wherein the corresponding vehicle is from the at least one vehicle;
(E) prompting the administrator account to engage a corresponding immobilizer, wherein the corresponding immobilizer is associated with the corresponding vehicle;
(F) relaying an engage signal from the admin PC device to the corresponding immobilizer;
(G) engaging the corresponding immobilizer, if the engage signal is received;
(H) disabling one or more data lines of the corresponding vehicle with the corresponding immobilizer;
(I) immobilizing the corresponding vehicle through the corresponding immobilizer;
(J) providing a plurality of temporary user accounts; and
(K) enabling the plurality of temporary user accounts to temporarily have authorization to engage the immobilizer on the corresponding vehicle, wherein each of the temporary user accounts store different user preferences that correspond to the method of choice to immobilize the vehicle.

2. The method of claim 1, wherein the immobilizer is retrofitted to the at least one vehicle.

3. The method of claim 1, wherein the immobilizer is installed into the at least one vehicle during the manufacturing process.

4. The method of claim 1, comprising the steps of:
providing a protective enclosure;
mounting the at least one the immobilizer within the protective enclosure.

5. The method as claimed in claim 1 comprising the steps of:
providing a communication module; and
enabling remote control of the immobilizer through the admin PC device during steps (D) through (K).

6. The method as claimed in claim 1, wherein one or more data lines to the ECU may be disabled with the immobilizer whether the vehicle is running or not.

7. The method as claimed in claim 1, wherein the immobilizer disables the ECU by connecting the immobilizer directly in line with the Onboard Diagnostic connector (OBD2 Connector).

8. The method as claimed in claim 1, wherein the immobilizer disables the ECU by connecting the immobilizer directly in line, at the ECU connector, by splicing the existing ECU's data lines into the immobilizer.

9. The method as claimed in claim 1, wherein the vehicle account enables the storage of the vehicle information on the immobilizer for enabling administrative functions.

10. The method as claimed in claim 1, comprising the steps of:
providing a user interface (UI);
enabling the administrator account to manage the at least one vehicle with the at least one immobilizer remotely, through the UI on a corresponding admin PC device.

11. (canceled)

12. (canceled)

13. (canceled)

14. A method of immobilizing a vehicle comprising the steps of:
(A) providing at least one vehicle account managed by at least one remote server, wherein the at least one vehicle account is associated with at least one vehicle;
(B) providing an administrator account managed by at least one remote server, wherein the administrator account is associated with an administrator personal computer (admin PC) device;
(C) attaching an immobilizer on the at least one vehicle, wherein the immobilizer is operably connected to the Engine Control Unit (ECU) of the at least one vehicle;
(D) prompting the administrator account to select a corresponding vehicle to be immobilized, wherein the corresponding vehicle is from the at least one vehicle;
(E) prompting the administrator account to engage a corresponding immobilizer, wherein the corresponding immobilizer is associated with the corresponding vehicle;
(F) relaying an engage signal from the admin PC device to the corresponding immobilizer;
(G) engaging the corresponding immobilizer, if the engage signal is received;
(H) disabling one or more components of the corresponding vehicle with the corresponding immobilizer, wherein the one or more components is selected from the group consisting of: engine's timing sensor, accelerator pedal signal sensor, engine's cam shaft sensor, and vehicle's fuel pump power wire/relay;
(I) immobilizing the corresponding vehicle through the corresponding immobilizer;
(J) providing a plurality of temporary user accounts; and
(K) enabling the plurality of temporary user accounts to temporarily have authorization to engage the immobilizer on the corresponding vehicle, wherein each of the temporary user accounts store different user preferences that correspond to the method of choice to immobilize the vehicle.

15. (canceled)

16. The method of claim 14, wherein the at least one immobilizer is retrofitted to the at least one vehicle.

17. The method of claim 14, wherein the at least one immobilizer is installed into the at least one vehicle during the manufacturing process.

18. The method of claim 14, comprising the steps of:
providing a protective watertight enclosure;
mounting the at least one the immobilizer within the protective watertight enclosure.

19. The method as claimed in claim 14 comprising the steps of:
providing a communication module; and
enabling remote control of the immobilizer through the admin PC device during steps (D) through (K).

20. The method as claimed in claim 14, comprising the steps of:
providing a user interface (UI) on a corresponding admin PC device;
enabling the administrator account to manage the at least one vehicle with the at least one immobilizer remotely, through the UI on the corresponding admin PC device.
